(19) United States
(12) Patent Application Publication
(10) Pub. No.: US 2019/0050607 A1
(43) Pub. Date: Feb. 14, 2019

(54) USB DEVICE FILTERING

(71) Applicant: HEWLETT-PACKARD DEVELOPMENT COMPANY, L.P., Houston, TX (US)

(72) Inventors: Irwan HALIM, Houston, TX (US); Lei MAN, Shanghai (CN)

(73) Assignee: HEWLETT-PACKARD DEVELOPMENT COMPANY, L.P., Houston, TX (US)

(21) Appl. No.: 16/074,725

(22) PCT Filed: Oct. 5, 2016
(86) PCT No.: PCT/US2016/055484

§ 371 Date: Aug. 1, 2018

(51) Int. Cl. G06F 21/85; G06F 13/42

(52) U.S. Cl. CPC G06F 21/85; G06F 2213/0042; G06F 13/4282

(57) ABSTRACT

Example implementations relate to USB device filtering. An example controller can receive a request to accept a USB device class from a USB device, filter device functions of the USB device class based on a comparison of the filtered device functions to a function filter list, and based on the comparison, pass a first device function onto an associated operating system or block a second device function from recognition by the associated operating system.

### BACKGROUND

A universal serial bus (USB) device is a device that utilizes USB connections to connect to a device. A USB device can include a cable, connector, and/or communication protocol used in a bus for connection, communication, and/or power supply between computers and electronic devices. A composite USB device (also known as a USB composite device) is a USB device that contains a plurality of USB interfaces and/or a USB device having multiple functions.

### BRIEF DESCRIPTION OF THE DRAWINGS

FIG. 1 illustrates a diagram of a computing system including a processing resource, a memory resource, and a number of modules according to an example;

FIG. 2 illustrates a diagram of a controller including a processing resource, a memory resource, and a number of modules according to an example;

FIG. 3 illustrates a diagram of a method for USB device filtering according to an example; and

FIG. 4 illustrates a diagram of another method for USB device filtering according to an example.

### DETAILED DESCRIPTION

A USB device can be used to standardize a connection of computer peripherals (e.g., keyboards, pointing device, digital cameras, smartphones, video game consoles, etc.) to computing devices, both to communicate and supply electric power. A composite USB device can be a peripheral device that supports more than one device function. Different devices can be implemented as composite USB devices. For instance, a composite USB device can include a plurality of logical sub-devices that are referred to as USB device functions. A single USB device may provide several functions, for example, a webcam (video device function) with a built-in microphone (audio device function). An example composite USB device is a smartphone including camera, audio, and storage functions. The functionality of USB devices can be defined by classes, communicated to the associated computing device to affect the loading of associated drivers for each connected USB device. A USB device class can be a category of devices with similar characteristics that perform common functions. For instance, a USB human interface device class can be a device class (e.g., a type of computer hardware) for human interface devices such as keyboards, game controllers, and Bluetooth devices, among others.

A filter driver may be utilized to filter USB devices and can include a driver that adds value to a peripheral device and/or supports a specialized device in a computing system. Composite USB device filtering according the present disclosure may include filtering a function (also known as a subclass) of the composite USB device.

However, some approaches to composite USB device filtering include blocking or allowing an entire USB device. For example, in such an approach, if it is desired to block a mass storage function of a USB composite USB device, the entire composite USB device is blocked. Similarly, if it is desired to allow the mass storage function of the composite USB device, the entire composite USB device is allowed. In contrast, examples of the present disclosure allow for selectively blocking or allowing functions of a composite USB device.

Other approaches to composite USB device filtering include using a specific vendor identification (ID) and a product ID of the composite USB device to try to filter functions of a composite USB device. However, similar composite USB devices can have different vendor IDs and product IDs. This can result in increased difficulty in deployment of composite USB device filter settings, and may work with a particular composite USB device. Similarly, some approaches use upper-level USB filter drivers to filter single function USB devices based on vendor ID and product ID. As used herein, a vendor ID indicates a vendor that developed the USB device, and a product ID indicates a model of the USB device created by the vendor. However, these approaches again may result in an entire device being blocked or allowed. For instance, a specific device vendor and/or other particularity can be defined, and an entire device is blocked based on that definition. In addition, these approaches may occur after USB device enumeration.

In contrast, examples of the present disclosure can use a lower-level USB filter driver and can allow for a more generic definition. For instance, examples of the present disclosure can include using a lower-level class USB filter driver to allow or filter out particular composite USB device functions during USB device enumeration. As used herein, an upper-level filter driver provides added-value features for a device. A lower-level filter driver, as used herein, modifies behavior of device hardware. An upper-level filter driver sits above a driver for the USB device (e.g., the function driver), and a lower-level filter driver sits below the driver (e.g., the function driver) and above the bus driver of the USB device. In some examples, functions of composite USB devices and/or non-composite USB devices can be filtered using a lower-level USB filter driver as described herein.

When a USB device is first connected to a computing device or other USB host, USB device enumeration can be started. As used herein, a computing device can be a mechanical or electrical device that transmits or modifies energy to perform or assist in the performance of human tasks. Examples include personal computers, laptops, tablets, and gaming consoles, among others. The computing device may have an operating system capable of being associated with a USB device connected to the computing device. The enumeration can start by the USB device receiving a reset signal. A data rate of the USB device can be determined during the reset signaling. In response, the USB device's information can read by an associated operating system and/or computing device, and the USB device can be assigned a unique address. As used herein, an associated operating system, is an operating system that will be in communication with the USB device to which it is connected (and in communication with) and will recognize and/or ignore a function of the USB device. If the USB device is supported by the associated operating system, USB device drivers used for communicating with the USB device can be loaded and the USB device can be set to a configured state. If the associated operating system is restarted, the enumeration process can be repeated for connected USB devices. Traffic flow to USB devices can be controlled such that a USB device transfers data on a bus in response to a request from a controller of an associated computing device and/or operating system.

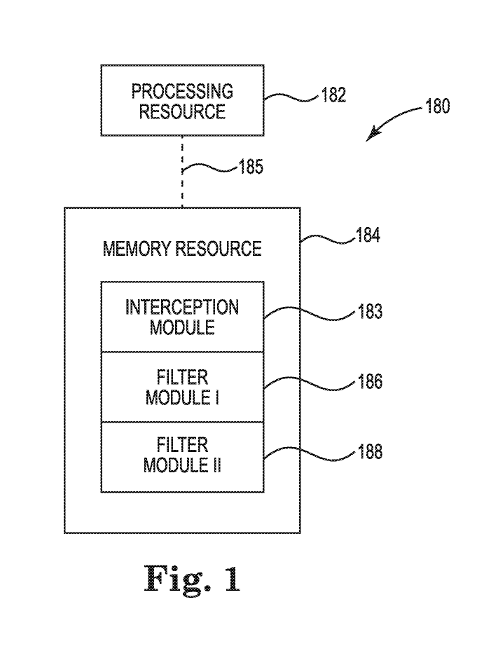

FIG. 1 illustrates a diagram of a computing system 180 including a processing resource 182, a memory resource 184, and a number of modules 183, 186, 188 according to an example. The computing system 180 can utilize instructions (e.g., software and/or firmware) hardware, and/or logic to perform a number of functions including those described herein. The computing system 180 can be a combination of hardware and program instructions configured to share information. The hardware, for example, can include a processing resource 182 and/or a memory resource 184 (e.g., computer readable medium (CRM), machine readable medium (MRM), etc., database, etc.).

A processing resource 182, as used herein, can include a processor capable of executing instructions stored by a memory resource 184. Processing resource 382 can be implemented in a single device or distributed across multiple devices. The program instructions (e.g., machine-readable instructions (MRI)) can include instructions stored on the memory resource 184 and executable by the processing resource 182 to implement a desired function (e.g., USB device filtering).

The memory resource 184 can be in communication with a processing resource 182. A memory resource 184, as used herein, can include memory components capable of storing instructions that can be executed by processing resource 182. Such memory resource 184 can be a non-transitory CRM or MRM. Memory resource 184 can be integrated in a single device or distributed across multiple devices. Further, memory resource 184 can be fully or partially integrated in the same device as processing resource 182 or it can be separate but accessible to that device and processing resource 182. Thus, it is noted that the computing system 180 can be implemented on a participant device, on a server device, on a collection of server devices, and/or a combination of the user device and the server device.

The memory resource 184 can be in communication with the processing resource 182 via a communication link (e.g., a path) 185. The communication link 185 can be local or remote to a machine (e.g., a computing system) associated with the processing resource 182. Examples of a local communication link 185 can include an electronic bus internal to a machine (e.g., a computing system) where the memory resource 184 is one of volatile, non-volatile, fixed, and/or removable storage medium in communication with the processing resource 182 via the electronic bus.

A module and/or modules 183, 186, 188 can include MRI that when executed by the processing resource 182 can perform a number of functions including those described herein. The number of modules 183, 186, 188 can be sub-modules of other modules. For example, the filter module I 186 and the filter module II 188 can be sub-modules and/or contained within the same computing system. In another example, the number of modules 183, 186, 188 can comprise individual modules at separate and distinct locations (e.g., MRM, etc.).

Each of the number of modules 183, 186, 188 can include instructions that when executed by the processing resource 182 can function as a corresponding engine. For example, the interception module 183 can include instructions that when executed by the processing resource 182 can function as an interception engine. Similar, each of the number of modules 186, 188 can include instructions that when executed by the processing resource 182 can function as engines.

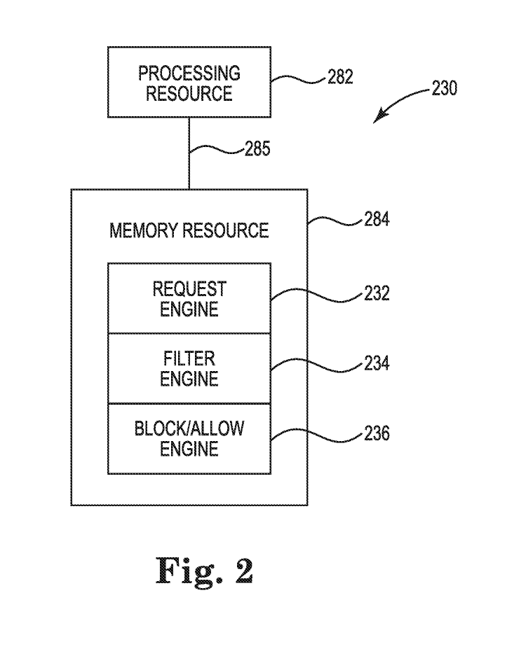

In some examples, engines can be part of a system (not illustrated) including a database, a subsystem, and the number of engines. The subsystem can include the number of engines in communication with the database via a communication link (e.g., link 285 as referenced in FIG. 2). The system can represent instructions and/or hardware of a network controller (e.g., system 230 as referenced in FIG. 2, etc.).

The number of engines can include a combination of hardware and programming to perform functions including those described herein. The instructions can include instructions (e.g., software, firmware, etc.) stored in a memory resource (e.g., CRM, MRM, etc.) as well as hard-wired program (e.g., logic).

In some examples, the number of modules 183, 186, 188 can be used in a software-as-a-service delivery model. For instance, components of computing system 180 can exist in a single computing system or multiple computing systems (e.g., distributed). For example, a web server or other computing system that is trusted by the user can provide services to a server of individual data streams, and/or act on behalf of the user as a processing agent for recovery.

In an example, interception module 183 can include instructions that when executed by the processing resource 182 can cause a computing system to intercept communication that includes composite USB device descriptor information between a plurality of composite USB devices and an associated operating system. A USB device can provide information about itself in data structures called USB descriptors. USB device descriptor information can include information associated with USB device descriptors, USB configuration descriptors, USB string descriptors, and USB interface associate descriptors. UBS device descriptors can include information about a USB device (composite or non-composite) as a whole, USB configuration descriptors can include information about USB capabilities in the form of a series of interfaces called a USB configuration (e.g., information about each device configuration), USB string descriptors can include descriptors referenced by other USB descriptors (e.g., Unicode text strings), and USB interface associate descriptors can include information that can allow the USB device to group interfaces that belong to a function. Other descriptors may also contribute to USB device descriptor information in some examples.

Intercepting the communication, in some examples, can include gathering information about classes and functions of the USB device. For instance, information can be gathered including device class information, vendor IDs, product IDs, functions of which the device is capable of performing, and configurations.

Filter module I 186 can include instructions that when executed by the processing resource 182 can cause a computing system to filter, based on a filter rule, a first function of the plurality of composite USB devices and allow recognition of the first function by the associated operating system. For instance, a filter rule, in this example, may define device functions to place on an allow list. That is, the filter rule can be used to create an allow list based on the filter rule. This list can include a list of functions for recognition by the associated operating system. A function not on the allow list can be blocked. This can be done during enumeration of the plurality of composite USB devices. For example, a composite USB device may include Bluetooth, audio, and storage functions. A filter rule set to allow audio functions may result in allowance of the audio function of the composite USB device and blockage of the Bluetooth and storage functions of the composite USB device. In such an example, an associated operating system does not recognize (e.g., ignores) the Bluetooth and storage functions.

Filter module II 188 can include instructions that when executed by the processing resource 182 can cause a computing system to filter, based on the filter rule, a second function of the plurality of composite USB device and block recognition of the second function by the associated operating system. For instance, a filter rule, in this example, may define particular functions to include on a block list. That is, the filter rule can be used to create a block list based on the filter rule. This list can include a list of functions to be blocked and as a result, ignored, by the associated operating device. A function not on the block list can be allowed and recognized by the associated operating device. This can be done during enumeration of the plurality of composite USB devices. For example, a composite USB device may include Bluetooth, audio, and storage functions. A filter rule set to block storage functions may result in allowance of the audio and Bluetooth functions of the composite USB device and blockage of the storage function of the composite USB device. In such an example, an associated operating system does not recognize (e.g., ignores) the storage function. More than one composite USB device function may be a designated in a filter rule in some examples.

In some examples, at least two of the plurality of composite USB devices have different product identifiers and/or at least two of the plurality of composite USB devices have different vendor IDs. For instance, if the filter rule allows keyboard functions of a composite USB device, keyboard functions from different vendors (e.g., having different vendor IDs) can be allowed. Similarly, if the filter rule allows audio functions of a composite USB device, different audio functions such as Bluetooth and microphone functions can be allowed, even with different product IDs. Similarly, filter rules may block functions of composite USB devices having different product and/or vendor IDs, in some examples.

FIG. 2 illustrates a diagram of an example controller 230 including a processing resource 282, a memory resource 284, and a number of engines 232, 234, 236 according to an example. For example, the controller 230 can be a combination of hardware and instructions for data recovery, data validation, and/or data authentication. The hardware, for example can include a processing resource 282 and/or a memory resource 284 (e.g., MRM, CRM, data store, etc.).

The processing resource 282, as used herein, can include a number of processors capable of executing instructions stored by a memory resource 284. The instructions (e.g., MRI) can include instructions stored on the memory resource 284 and executable by the processing resource 282 to implement a desired function (e.g., USB device filtering).

The memory resource 284, as used herein, can include a number of memory components capable of storing non-transitory instructions that can be executed by processing resource 282. Memory resource 284 can be integrated in a single device or distributed across multiple devices. Further, memory resource 284 can be fully or partially integrated in the same device as processing resource 282 or it can be separate but accessible to that device and processing resource 282. Thus, it is noted that the controller 230 can be implemented on an electronic device and/or a collection of electronic devices, among other possibilities.

The memory resource 284 can be in communication with the processing resource 282 via a communication link (e.g., path) 285. The communication link 285 can be local or remote to an electronic device associated with the processing resource 282. The memory resource 284 includes a number of engines (e.g., request engine 232, filter engine 234, block/allow engine 236, etc.). The memory resource 284 can include additional or fewer engines than illustrated to perform the various functions described herein.

The number of engines can include a combination of hardware and instructions to perform a number of functions described herein (e.g., USB device filtering). The instructions (e.g., software, firmware, etc.) can be downloaded and stored in a memory resource (e.g., MRM) as well as a hard-wired program (e.g., logic), among other possibilities.

The request engine 232 can receive a request to accept a USB device class from a USB device. For instance, a device class may be presented along with information about the USB device class via descriptors. For instance, a configuration descriptor for the USB device can include a configuration header followed by descriptors for an interface or interfaces associated with the USB device, as well as descriptors for each interface. In some examples, the USB device is a composite USB device. A configuration descriptor for a composite USB device includes a configuration header followed by descriptors for interfaces associated with the composite USB device, as well as additional descriptors for each of the interfaces.

The filter engine 234 can filter a device function of the USB device class based on a comparison of the filtered device function to a function filter list. The function filter list, in some examples, can include a device function block list and/or a device function allow list. A lower-level USB filter driver can be used to filter the device functions, in some examples. In such an example, a single USB filter driver can be used and can have a plurality of functions. The single USB filter driver can comply with a filter rule or filter rules presented to the USB filter driver. While a single USB filter driver is described herein, more than one USB filter driver may be used.

The block/allow engine 236 can determine whether to pass the device function onto an associated operating system or block the device function from recognition by the associated operating system. This can be based on the comparison, for example. For instance, if the function filter list is a block list that includes the device function, the device function can be blocked from recognition by the associated operating system. In contrast, if the function filter list is an allow list that includes the device function, the device function can be passed onto the associated operating system. If the function filter list is a block list that does not include the device function, the device function can be passed onto the associated operating system. If the function filter list is an allow list that does not include the device function, the device function can be blocked from recognition by the associated operating system. The controller 230 can pass the first device function and/or block the device function during enumeration of the USB device, in some examples.

In some examples, a USB device can be either blocked or allowed. For instance, a filter rule may exist to place a keyboard on a USB device allow list. In such an example, if a first USB device includes a keyboard and a second USB device includes keyboard with a built-in smartcard reader, the keyboard works in both situations. However, the smartcard reader may not work. Conversely, in an example where a filter rule exists to place a keyboard on a USB device block list, neither the first USB device nor the second USB device works. However, with respect to the second USB device, the smartcard reader may function, while the keyboard does not because a device manager or plug-and-play manager may identify the keyboard and the smartcard reader as separate devices (e.g., “keyboard device” and “smart card reader device”).

In some examples, the controller 230 can include instructions executable to intercept communication between the USB device and the associated operating system and filter the device function of the USB device based on the comparison of the filtered device function to the function filter list and the intercepted communication. For example, the intercepted communication can include information about USB device configurations and functions, among other information. This information can be used to filter the device function of the USB device. For instance, the information can be compared to the function filter list, and a decision can be made to block or allow the device function from recognition by the associated operating system.

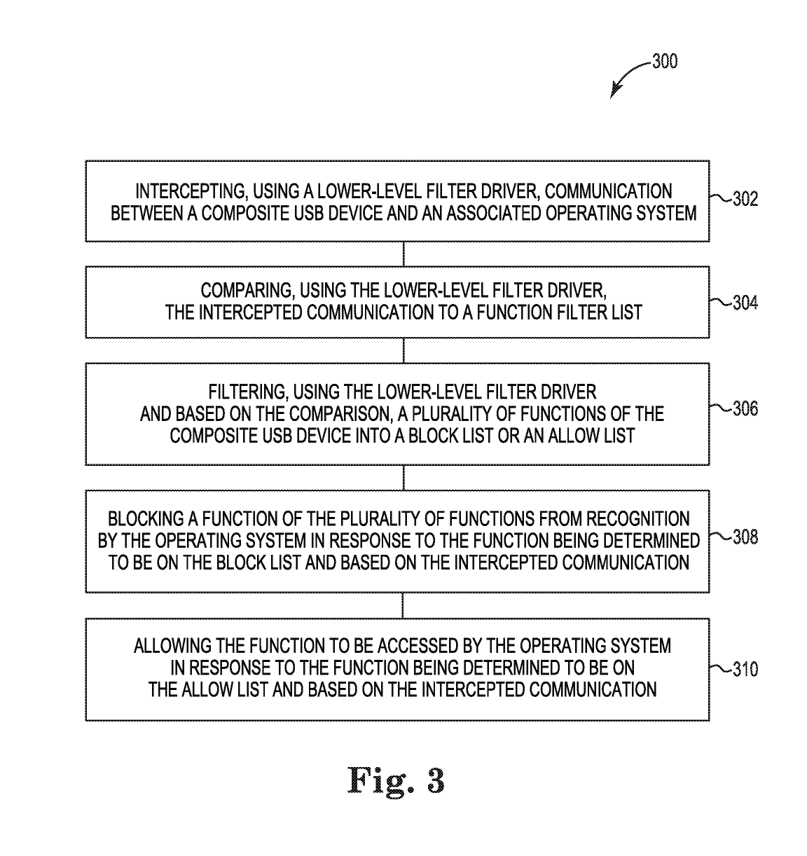

FIG. 3 illustrates a diagram of a method 300 for USB device filtering according to an example. At 302, method 300 can include intercepting, using a lower-level filter driver, communication between a composite USB device and an associated operating system. In some examples, intercepting communication includes intercepting descriptor information of the composite USB device. For instance, communication can be intercepted to determine information with respect to composite USB device classes, functions, and/or configurations, among others. While method 300 is described with respect to composite USB devices, non-composite USB devices may be filtered in a similar manner using the lower-level filter driver.

At 304, method 300 can include comparing, using the lower-level filter driver, the intercepted communication to a function filter list, and at 306, method 300 can include filtering, using the lower-level filter driver and based on the comparison, a plurality of functions of the composite USB device into a block list and/or an allow list. For instance, the function filter list can include functions and/or functions to block and/or allow. Information collected during the communication interception can be compared to the function filter list. For instance, in an example, the intercepted communication includes information that a connected USB composite device includes storage, audio, and Bluetooth functions.

Method 300 can include, at 308, blocking a function of the plurality of functions from recognition by the operating system in response to the function being determined to be on the block list and based on the intercepted communication. For instance, when the intercepted communication is compared to the function filter list, and a particular function is found in both the intercepted communication and on the block list, the particular function is blocked from recognition. Similarly if the function filter list is an allow list, and the particular function is not on the allow list, it can be blocked from recognition by the operating system.

At 310, method 300 can include allowing the function to be accessed by the operating system in response to the function being determined to be on the allow list and based on the intercepted communication. For instance, when the intercepted communication is compared to the function filter list, and a particular function is found in both the intercepted communication and on the allow list, the particular function is passed through for recognition by the operating system. Similarly, if the function filter list is a block list, and the particular function is not on the block list, it can be passed through for recognition by the operating system.

In some examples, method 300 can include filtering, using the lower-level filter driver and based on the comparison, a plurality of interfaces of the composite USB device into the block list or the allow list. Method 300 can include blocking, based on the filtering, a first interface of the plurality of interfaces determined to be on the block list from recognition by the operating system and allowing, based on the intercepted communication, a second interface of the plurality of interfaces determined to be on the allow list to be accessed by the operating system. An interface can include a particular function of a composite USB device. For instance, an interface can include a human interface device class as previously described, and can include device classes including keyboards, mice, game controllers, and alphanumeric display devices, among others. In such an example, a function can be allowed or blocked based on the interface class, instead of specifying both a vendor ID and a product ID.

Some examples can include filtering, using the lower-level filter driver, the plurality of functions of the composite USB device into the block list and/or the allow list based on the comparison or a plurality of filter rules. For instance, a filter rule or plurality of filter rules may define what functions can be allowed or blocked from recognition by an operating system. The filter rule or plurality of filter rules may define what is on the function filter list, and whether the function filter list is an allow list or a block list. A lower-level filter can filter the functions based on the filter rule or plurality of filter rules and the function filter list For example, if a filter rule defines that storage functions are allowable, the function filter list may be an allow list including storage functions or a block list including a function or functions other than storage functions. The lower-level filter can filter functions accordingly, allowing storage functions to pass on to the operating system while blocking other functions from recognition by the operating system.

Similarly, if a filter rule defines that storage functions are to be blocked, the function filter list may be a block list including storage functions or an allow list including a function or functions other than storage functions. The lower-level filter can filter functions accordingly, blocking storage functions from recognition by the operating system while allowing other functions to pass on to the operating system.

In some examples, a single filter rule can be used for each composite USB device, including the same filter rule being used among composite USB devices of different brands (e.g., having different vendor IDs). This can allow for selective allowance or blockage of a composite USB device functionality. For instance, when a smartphone is connected via a USB port, a lower-level filter driver can filter functions such that a camera function is allowed, but audio and storage functions are not recognized by an operating system, regardless of the smartphone brand.

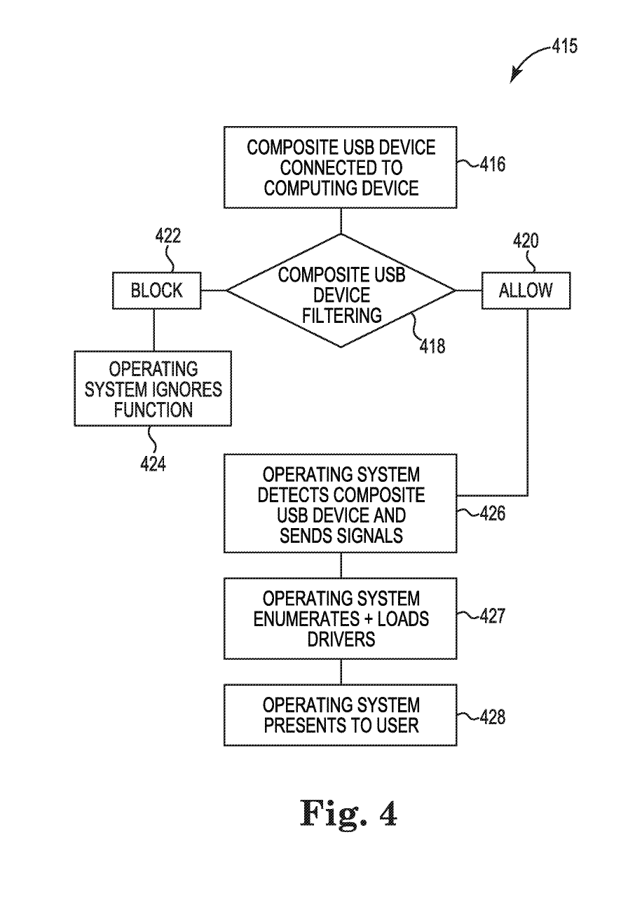

FIG. 4 illustrates a diagram of another method 415 for USB device filtering according to an example. At 416, a composite USB device is connected to a computing device. For instance, a request may be received to accept a function of a composite USB device. An operating system of the computing device can detect a new USB device (composite or non-composite) connected to the computing device. While method 415 is described with respect to composite USB devices, non-composite USB devices may be filtered in a similar manner using the lower-level filter driver.

At 418, method 415 can include composite USB device filtering. For instance, a lower-level filter driver can filter functions of the composite USB device based on filter rules and a comparison to a function filter list. In some examples, filter rules can define what functions of a composite USB device to block and/or allow. A function filter list can be created based on these filter rules, and functions of the composite USB device can be blocked or allowed based on a comparison to the function filter list.

If, at 422, it is determined that a function of the composite USB device is to be blocked, the operating system ignores the function at 424. For instance, if a function is blocked (e.g., on a block list) based on the filter rules and/or comparison, the operating system is not allowed to recognize the function and ignores the function. Similarly, if an allow list is created, and a particular function is not on the allow list, it can be ignored by the operating system at 424.

If, at 420, it is determined that a function of the composite USB device is allowed, the operating system can detect the composite USB device, and the operating system can begin sending signals to the USB device at 426. The signals can include, for instance, inquiries to the USB device regarding identification, capabilities, etc. The USB device can respond back to the operating system with descriptors identifying the composite USB device and its functions. For instance, if a function is allowed (e.g., on an allow list) based on the filter rules and/or comparison, the operating system is allowed to recognize the function at 426. Similarly, if a block list is created, and a particular function is not on the block list, it can be allowed at 426.

Method 415, at 426, can include the operating system enumerating and loading drivers, and at 428, method 415 can include the operating system presenting the USB device function to a user. For instance, the operating system acknowledges that that installation of the composite USB device and any associated drivers is complete and/or recognized. A user is able to utilize the allowed function. For instance, if a user wants to use an audio function of a smartphone connected to a computing device, and the audio function is on an allow list (or not on a block list), the user audio function is presented to the user.

In the foregoing detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

What is claimed:

1. A controller comprising a processing resource in communication with a memory resource including instructions executable to:
receive a request to accept a universal serial bus (USB) device class from a USB device;
filter a device function of the USB device class based on a comparison of the filtered device function to a function filter list; and
based on the comparison, determine whether to pass the device function onto an associated operating system or block the device function from recognition by the associated operating system.

2. The controller of claim 1, wherein the USB device is a composite USB device.

3. The controller of claim 1, wherein the function filter list is a device function block list.

4. The controller of claim 1, wherein the function filter list is a device function allow list.

5. The controller of claim 1, further comprising instructions executable to determine whether to pass the first device function onto the associated operating system or block the device function from recognition by the associated operating system during enumeration of the USB device.

6. The controller of claim 1, further comprising instructions executable to filter a device function of the USB device class based on a comparison of the filtered device function to the function filter list using a lower-level USB filter driver.

7. The controller of claim 1, further comprising instructions executable to:
intercept communication between the USB device and the associated operating system; and
filter the device function of the USB device based on the comparison of the filtered device function to the function filter list and the intercepted communication.

8. A method, comprising:
intercepting, using a lower-level filter driver, communication between a composite USB device and an associated operating system;
comparing, using the lower-level filter driver, the intercepted communication to a function filter list;
filtering, using the lower-level filter driver and based on the comparison, a plurality of functions of the composite USB device into a block list or an allow list;
blocking a function of the plurality of functions from recognition by the operating system in response to the function being determined to be on the block list and based on the intercepted communication; and
allowing the function to be accessed by the operating system in response to the function being determined to be on the allow list and based on the intercepted communication.

9. The method of claim 8, wherein intercepting communication includes intercepting descriptor information of the composite USB device.

10. The method of claim 8, further comprising:
filtering, using the lower-level filter driver and based on the comparison, a plurality of interfaces of the composite USB device into the block list or the allow list;
blocking, based on the filtering, a first interface of the plurality of interfaces determined to be on the block list from recognition by the operating system; and
allowing, based on the intercepted communication, a second interface of the plurality of interfaces determined to be on the allow list to be accessed by the operating system.

11. The method of claim 8, further comprising filtering, using the lower-level filter driver, the plurality of functions of the composite USB device into the block list and the allow list based on the comparison and a plurality of filter rules.

12. A non-transitory machine-readable medium storing instructions executable by a processing resource to cause a computing system to:
intercept communication including composite USB device descriptor information between a plurality of composite USB devices and an associated operating system; and
during enumeration of the plurality of composite USB devices:
filter, based on a filter rule, a first function of the plurality of composite USB devices and allow recognition of the first function by the associated operating system; and
filter, based on the filter rule, a second function of the plurality of composite USB devices and block recognition of the second function by the associated operating system.

13. The non-transitory machine-readable medium of claim 12, wherein at least two of the plurality of composite USB devices have different product identifiers.

14. The non-transitory machine-readable medium of claim 12, wherein at least two of the plurality of composite USB devices have different vendor identifiers.

15. The non-transitory machine-readable medium of claim 12, further comprising instructions executable to create a block list or an allow list based on the filter rule.
